(19) United States
(12) Patent Application Publication
(10) Pub. No.: US 2007/0215064 A1
(43) Pub. Date: Sep. 20, 2007

(54) Tangle-free tie out stake

(75) Inventor: Troy Petersen, Rosemount, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Royal Pet Incorporated, Eagan, MN (US)

(21) Appl. No.: 11/378,160

(22) Filed: Mar. 17, 2006

(51) Int. Cl. A01K 1/04

(52) U.S. Cl. 119/786

(57) ABSTRACT

An apparatus for limiting an animal's movement includes a housing having a throughbore for accepting a shaft of a stake where the housing contains a retractable tether. A substantially conical support disposes about the shaft and attaches thereto and wherein the substantially conical support retains the housing at a selected elevation on the shaft and wherein a retaining mechanism retains the housing on the shaft.

### BACKGROUND OF THE INVENTION

The present invention relates to a restraint for an animal. More particularly, the present invention relates to a retractable tie out for the animal.

Tie outs are used to limit the movement of animals, such as domesticated animals including, but not limited to, dogs, horses and cows. A typical tie out includes a tether of a fixed length having one end secured to the animal and the other end secured to an anchor that retains the anchored end of the tether in a selected location. Attaching the tether to the anchor prevents the animal from running free and confines the animal to roam within a generally circular area defined by the length of the tether. A typical anchor includes a stake that is forced into the ground which can be repositioned or a post that is permanently positioned in the ground.

A longer tether gives the restrained animal greater freedom of movement within a larger area than the area provided with a shorter tether. However, a longer tether has a tendency of becoming tangled in the terrain, such as a rock or a tree, which consequently decreases the freedom of movement of the animal and defeats the purpose of the longer tether. Also, the animal may tangle the tether around the anchor which may also limit freedom of movement of the animal. A longer tether, designed to provide the animal greater freedom to move, may cause a reduction in the freedom of movement of the animal if the tether becomes entangled in an obstacle.

To reduce the likelihood of the tether becoming tangled in an obstacle, while still providing the freedom of movement of a longer tether, the tether may be attached to a retractable reel. The reel is biased such that the tether retracts into the reel as tension is removed from the tether. When the animal applies force upon the tether that overcomes the bias, the reel rotates to increase the length of the tether. When the animal moves toward the anchor, the biased reel retracts the tether onto the reel and thereby reduces the length of the tether. As the length of the tether becomes shorter, the likelihood of the tether becoming entangled in an obstacle is reduced.

While retractable tethers reduce the likelihood of the tie out becoming entangled in the terrain, the tether still has the potential of becoming entangled around the stake. When the tether becomes entangled about the stake, the freedom of movement of the animal is unnecessarily restricted.

### SUMMARY OF THE INVENTION

The present invention includes an apparatus for limiting an animal's movement. The apparatus includes a housing having a throughbore for accepting a shaft of a stake where the housing contains a retractable tether. A substantially conical support disposes about the shaft and attaches thereto and wherein the substantially conical support retains the housing at a selected elevation on the shaft and wherein a retaining mechanism retains the housing on the shaft.

### BRIEF DESCRIPTION OF THE DRAWINGS

FIG. 1 is a perspective view of the retractable tie out of the present invention.

FIG. 2 is a top view of a dog secured to the retractable tie out of the present invention.

FIG. 3 is a partial exploded view of the retractable tie out of the present invention.

FIG. 4 is a sectional view of the present invention along section line 4-4 in FIG. 3.

### DETAILED DESCRIPTION OF THE PREFERRED EMBODIMENTS

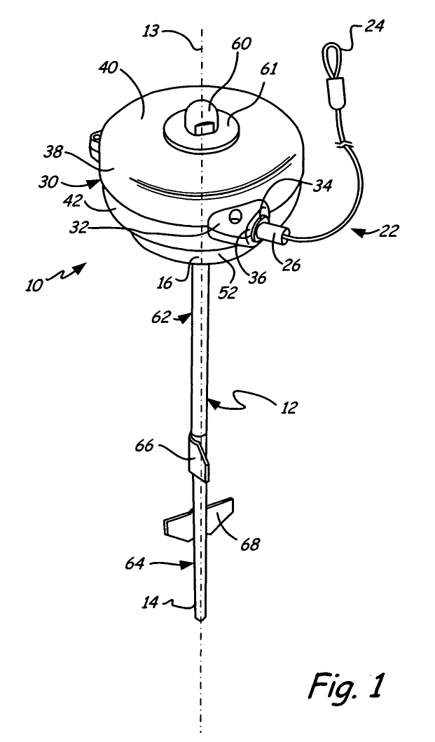

A retractable tie out of the present invention is generally illustrated in FIG. 1 at 10. The retractable tie out 10 includes a stake 12 having a distal end 14 for forcing into a surface such as soil to secure the retractable tie out 10 in a selected position.

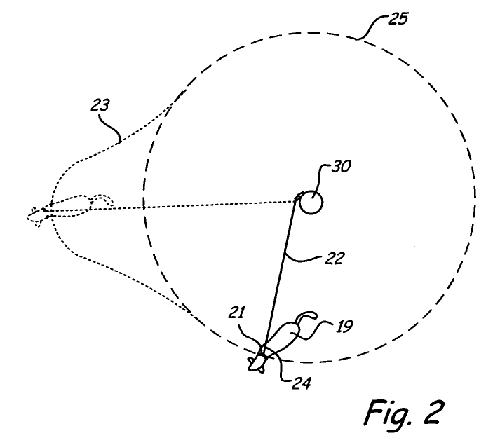

Referring to FIGS. 1 and 2, a tether 22 includes a distal end 24 that attaches to an animal such as a dog 19. The dog 19 is secured to the distal end 24 of the tether 22, preferably by securing the distal end 24 of the tether 22 to a collar 21 positioned about a neck of the dog 19. Besides being capable of tethering a dog 19, the tie out 10 of the present invention can also tether other animals, such as but not limited to, a cow, a horse, a goat and a sheep.

A stop 26 is positioned about the tether 22 proximate the distal end 24 where the stop 26 engages a front surface 36 of a port 32 in a housing 30 to prevent the distal end 24 from retracting into the housing 30. The port 32 includes an aperture 34 through which the tether 22 extends and retracts to adjust a length of the tether 22.

The housing 30 has a substantially circular sidewall 38 defined by an upper half 40 and a lower half 42. The housing 30 is rotatably attached to the stake 12 proximate a proximal end 16 where the housing 30 rotates about an axis 13 of the stake 12. As the dog 19 moves, the housing 30 rotates about the axis 13 of the stake 12 such that the tether 22 remains free of the stake 12.

Referring to FIGS. 2-4, the tether 22 is secured to a reel 20 that is positioned about the stake 12 and within a cavity 44 defined by the upper and lower halves 42, 40, respectively. The reel 20 rotates about the axis 13 of the stake 12 to uncoil and coil the tether 22 onto the reel 20 to adjust a length of the tether 22. Configurations of the housing other than circular are within the scope of the present invention provided that the reel 20 is permitted to rotate within the housing 30.

Referring to FIG. 2, as the dog 19 exerts a force on the tether 22, the tether 22 comes under tension and uncoils from the reel 20. As the length of the tether 22 increases, the dog 19 has more area to freely move as indicated by perimeter 23. However, when the dog 19 moves toward the stake 12, tension lessens on the tether 22, and a retracting mechanism applies a force upon the reel 20 to reverse the rotation of the reel 20 about the axis 13 of the stake 12. As the reel 20 rotates in the reverse rotational direction, the tether 22 is wound about the reel 20 and the area where the dog 19 can move lessens as indicated by perimeter 25 which also lessens the likelihood of the tether 22 becoming entangled in the terrain.

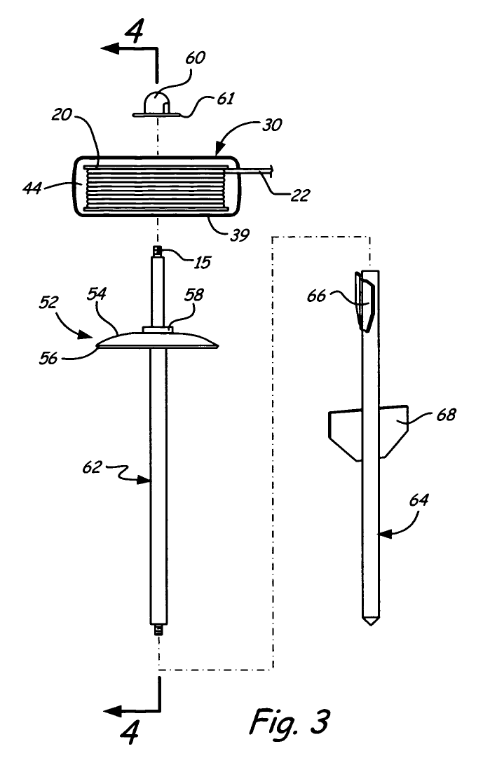

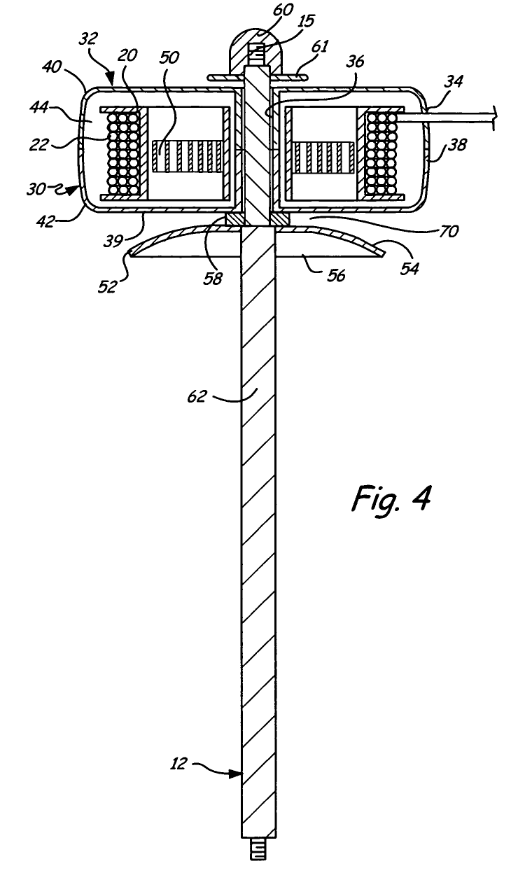

Referring to FIGS. 3 and 4, a preferred retracting mechanism includes a coil spring 50 positioned within the cavity 44 of the housing 30 where the coil spring 50 engages the reel 20. As the dog 19 uncoils the tether 22 by applying tension to the tether 22, the coil spring 40 constricts. As the dog 19 further uncoils the tether 22, the coil spring 50 further constricts, requiring greater tension to overcome the bias of the coil spring 50. When the dog 19 releases tension on the tether 22 by moving toward the stake 12, the coil spring 50 overcomes the tension applied by the dog 19 on the tether 22, and the coil spring 50 uncoils, thereby reversing the rotation of the reel 20 and rewinds the tether 22 onto the reel 20. As the tether 22 rewinds onto the reel 20, the length of the tether 22 decreases, and thereby reduces the likelihood of the tether 22 becoming tangled in the terrain.

The housing 30 and the reel 20 are retained in a selected position on the stake 12 by slidably positioning the stake 12 through a through bore 36 that is substantially centrally located in the housing 30 and engages a bottom surface 39 of the housing 30 with a spacer 58 positioned about the stake 12. While the spacer 52 is discussed, the spacer 52 is not necessary to practice the present invention.

A support 52 is fixedly attached to the stake 12, preferably with a weld, and supports the spacer 52 and the housing 30 in a selected elevated position on the stake 12. The support 52 includes a substantially circular perimeter 56 and an upper surface 54 having a convex configuration. While the support 52 with a convex upper surface 56 is preferred, other configurations of the support 52 that allow gravity to slide the tether 22 off the support 52 are within the scope of the present invention including a conical configuration, a frusto-conical configuration and a pyramid. While a fixed attachment of the support 52 to the stake 12 is specifically discussed, other attachments of the support 52 to the stake 12 are within the scope of the present invention, including, but not limited to a threaded engagement and engaging the support with a shoulder on the stake.

The housing 30 and the reel 20 are retained on the stake 12 with a nut 60 threadably engaging a threaded portion 15 of the stake 12 proximate the distal end 14. The nut 60 threadably engaging the threaded portion 15 of the stake 12 along with the support 52 fixedly attached to the stake 12, retains the reel 20 and the housing 30 at the selected elevation on the stake 12. A washer 61 preferably is positioned between the housing 30 and the nut 60 to prevent the nut 60 from galling the housing 30. While a threaded engagement for retaining the housing 30 and the reel 20 on the stake 12 is preferred, other retaining mechanisms are within the scope of the present invention including, but not limited to, a snap ring, a pin engaging a through bore in the stake and a frictional engagement of a cap on the distal end of the stake.

Referring to FIGS. 1 and 3, the stake 12 includes a shaft portion 62 that is threadably attached to an anchor portion 64. The retractable tie out 10 is compactly packaged and/or stored when the shaft portion 62 is detached from the anchor portion 64. However a stake 12 of a unitary construction having a shaft section and an anchor section is within the scope of the present invention.

An upper wing 68 and a lower wing 66 are fixedly attached to the anchor portion 64 where the upper and lower wings 68, 66, respectively, are preferably forced into the ground 18. The upper and lower wings 68, 66 are preferably positioned on the anchor portion 64 such that vertical planes that define the wings 68, 66 intersect at substantially right angles. While wings 68, 66 are shown positioned at substantially right angles, other configurations of the wings 68, 66 are within the scope of the present invention.

The wings 68, 66 aid in preventing the anchor portion 64 from rotating in the ground 18 when the dog 19 applies tension to the tether 22 and thereby aid in retaining the stake 12 in the selected location. While a stake 12 with substantially perpendicular wings 66, 68 is preferred, a stake having one wing or no wings is also within the scope of the present invention.

The tether 22 provides adequate flexibility for the dog 19 to freely move within the area. However, the tether 22 should include enough rigidity such that the tether 22 does not sharply bend and thereby prevent the dog 19 from tangling the tether 22 on obstacles on the ground 18. Further, the tether 22 preferably has a diameter or thickness that positions within a gap 70 defined by the bottom surface 39 of the housing 30 and the upper surface 54 of the support 52.

When the tether 22 is positioned within the gap 70, the downwardly sloped convex upper surface 54 allows gravitational force to slide the tether 22 off of the upper surface 54 of the support 52 and thereby prevents the tether 22 from becoming entangled between the housing 30 and the support 52. If the dog 19 moves such that the tether 22 engages the stake 12 below the support 52, the tether 22 engages the circular perimeter 56 of the support 52 that prevents the tether from becoming entangled with the stake 12.

The tether 22 preferably includes a metal cable having a plastic or polymeric coating. While a cable is specifically discussed, other types of tethers are within the scope of the present invention including, but not limited to, a chain, a rope and a strap.

Although the present invention has been described with reference to preferred embodiments, workers skilled in the art will recognize that changes may be made in form and detail without departing from the spirit and scope of the invention.

What is claimed is:

1. An apparatus for limiting an animal's movement comprising:
a housing having a throughbore and containing a retractable tether;
a stake having a shaft extending through the through bore;
a substantially conical support disposed about the shaft and attached thereto and wherein the substantially conical support retains the housing at a selected elevation on the shaft; and
a retaining mechanism for retaining the housing on the shaft.

2. The apparatus of claim 1 and wherein the substantially conical support further comprises a substantially convex surface.

3. The apparatus of claim 1 and wherein the housing further comprises a reel for retracting and lengthening the tether and wherein the reel positions within the housing and about the shaft.

4. The apparatus of claim 3 and further comprising a coil spring for engaging the reel and wherein the coil spring retracts the tether within the housing about the reel.

5. The apparatus of claim 1 and wherein the tether comprises a cable.

6. The apparatus of claim 1 and wherein the tether comprises a chain, a rope or a strap

7. The apparatus of claim 1 and wherein the retaining mechanism comprises a nut for threadably engaging the shaft.

8. The apparatus of claim 1 and wherein the stake comprises:
a upper portion having the shaft; and
a lower portion for attaching to the upper portion and for anchoring into a surface.

9. The apparatus of claim 8 and wherein the lower portion comprises at least one wing attached thereto for preventing rotation of the lower portion within the surface.

10. The apparatus of claim 1 and wherein the housing comprises a port with an aperture for slidably accepting the tether.

11. The apparatus of claim 1 and wherein the housing comprises:
an upper portion; and
a lower portion for mating with the upper portion and wherein the upper portion and lower portion contain the tether therein.

12. A retractable tie out for securing to an animal comprising:
a housing having a throughbore;
a reel positioned within the housing and containing a retractable tether;
a stake having a shaft extending through the through bore;
a support disposed about the shaft and attached thereto and having a substantially convex upper surface and wherein the support retains the housing at a selected elevation on the shaft; and
a retaining mechanism for retaining the housing on the shaft.

13. The tie out of claim 12 and further comprising a coil spring for engaging the reel and wherein the coil spring retracts the tether within the housing about the reel.

14. The tie out of claim 12 and wherein the tether comprises a cable.

15. The tie out of claim 12 and wherein the tether comprises a chain, a rope or a strap

16. The tie out of claim 13 and wherein the retaining mechanism comprises a nut for threadably engaging the shaft.

17. The tie out of claim 12 and wherein the stake comprises:
a upper portion having the shaft; and
a lower portion for attaching to the upper portion and for anchoring into a surface.

18. The tie out of claim 17 and wherein the lower portion comprises at least one wing attached thereto for preventing rotation of the lower portion within the surface.

19. The tie out of claim 12 and wherein the housing comprises a port with an aperture for slidably accepting the tether.

20. The tie out of claim 12 and wherein the housing comprises:
an upper portion; and
a lower portion for mating with the upper portion and wherein the upper portion and lower portion contain the tether therein.
